(19) United States
(12) Patent Application Publication
(10) Pub. No.: US 2022/0067380 A1
(43) Pub. Date: Mar. 3, 2022

(54) EMULATION SERVICE FOR PERFORMING CORRESPONDING ACTIONS BASED ON A SEQUENCE OF ACTIONS DEPICTED IN A VIDEO

(71) Applicant: Perfect Mobile Corp., New Taipei City (TW)

(72) Inventor: Teng-Yuan HSIAO, Taipei City (TW)

(21) Appl. No.: 17/410,078

(22) Filed: Aug. 24, 2021

Related U.S. Application Data
(60) Provisional application No. 63/069,869, filed on Aug. 25, 2020.
(60) Provisional application No. 63/069,866, filed on Aug. 25, 2020.

(51) Int. Cl. G06K 9/00; G06T 11/60; G06F 16/78; A45D 44/00; G06F 16/783

(52) U.S. Cl. CPC G06K 9/00711; G06K 9/00281; G06T 11/60; G06K 2009/00738; A45D 44/005; G06F 16/7837; G06F 16/7867

(57) ABSTRACT

A media casting device detects facial feature points of a beauty advisor and detects the beauty advisor performing a sequence of operations relating to application of cosmetic products on a facial region of the beauty advisor. The media casting device detects a corresponding timestamp for each operation and detects a position of a cosmetic product with respect to facial feature points of the beauty advisor during each of the sequence of operations. The media casting device detects a cosmetic product utilized by the beauty advisor during each of the sequence of operations and generates metadata comprising the sequence of operations, the position of each cosmetic product, the corresponding timestamps, and each detected cosmetic product. The media casting device then transmits the metadata to a client device.

### CROSS-REFERENCE TO RELATED APPLICATION

This application claims priority to, and the benefit of, U.S. Provisional Patent Application entitled, “Virtual Makeup Tutorial on Live Show Viewer's Face,” having Ser. No. 63/069,869, filed on Aug. 25, 2020, and U.S. Provisional Patent Application entitled, “Virtual Makeup Tutorial on Ads Audience's Face,” having Ser. No. 63/069,866, filed on Aug. 25, 2020, which are incorporated by reference in their entireties.

### TECHNICAL FIELD

The present disclosure relates to an emulation service for performing corresponding actions based on a sequence of actions depicted in a video.

### BACKGROUND

Consumers invest a substantial amount of money in makeup tools and accessories. However, it can be challenging for consumers to achieve the same results as a makeup professional even with the aid of conventional self-help guides.

### SUMMARY

In accordance with one embodiment, a media casting device detects facial feature points of a beauty advisor and detects the beauty advisor performing a sequence of operations relating to application of cosmetic products on a facial region of the beauty advisor. The media casting device detects a corresponding timestamp for each operation and detects a position of a cosmetic product or cosmetic tool with respect to facial feature points of the beauty advisor during each of the sequence of operations. The media casting device detects a cosmetic product utilized by the beauty advisor during each of the sequence of operations and generates metadata comprising the sequence of operations, the position of each cosmetic product cosmetic tool, the corresponding timestamps, and each detected cosmetic product. The metadata may also include the coordinates of the position of the cosmetic product/tool relative to the facial feature points. The media casting device then transmits the metadata to a client device.

In accordance with another embodiment, a media casting device obtains a multimedia file depicting a beauty advisor performing a sequence of operations relating to application of cosmetic products on a facial region of the beauty advisor. The media casting device obtains metadata, wherein the metadata comprises: the sequence of operations, a position of a cosmetic product or cosmetic tool, corresponding timestamps, and each cosmetic product utilized by the beauty advisor. The media casting device detects manipulation of a user interface control of a user of a client device. Responsive to detecting the manipulation of the user interface control, the media casting device causes the client device to capture a video of a facial region of the user, causes the client device to track facial feature points of the user in the video, and causes the client device to perform virtual application of makeup effects on the facial feature points of the user of the client device according to the metadata. The virtual application of makeup effects on the facial feature points of the user is displayed in a user interface on the client device and is performed as corresponding operations are performed by the beauty advisor.

Another embodiment is a non-transitory computer-readable storage medium storing instructions to be implemented by a media casting device. The media casting device comprises a processor, wherein the instructions, when executed by the processor, cause the media casting device to detect facial feature points of a beauty advisor and detect the beauty advisor performing a sequence of operations relating to application of cosmetic products on a facial region of the beauty advisor. The processor is further configured by the instructions to detect a corresponding timestamp for each operation, detect a position of a cosmetic product or cosmetic tool with respect to facial feature points of the beauty advisor during each of the sequence of operations, and detect a cosmetic product utilized by the beauty advisor during each of the sequence of operations. The processor is further configured by the instructions to generate metadata comprising the sequence of operations, the position of each cosmetic product, the corresponding timestamps, and each detected cosmetic product. The metadata may also include the coordinates of the position of the cosmetic product relative to the facial feature points. The processor is further configured by the instructions to transmit the metadata to a client device.

Another embodiment is a non-transitory computer-readable storage medium storing instructions to be implemented by a client device. The client device comprises a processor, wherein the instructions, when executed by the processor, cause the client device to obtain a video and metadata from a media casting device, the video depicting a beauty advisor performing a sequence of operations relating to application of cosmetic products on a facial region of the beauty advisor. The processor is further configured by the instructions to capture a video of a user of the client device and detect facial feature points of the user. The processor is further configured by the instructions to perform virtual application of makeup effects on the facial feature points of the user according to the metadata, wherein the virtual application of makeup effects on the facial feature points of the user is displayed in a user interface and is performed as corresponding operations are depicted in the video obtained from the media casting device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various aspects of the disclosure can be better understood with reference to the following drawings. The components in the drawings are not necessarily to scale, with emphasis instead being placed upon clearly illustrating the principles of the present disclosure. Moreover, in the drawings, like reference numerals designate corresponding parts throughout the several views.

FIG. 1 is a block diagram of a networked environment that includes a media casting device and a client device for implementing an emulation service for performing corresponding actions based on a sequence of actions performed by a beauty advisor according to various embodiments of the present disclosure.

FIG. 2 is a schematic diagram of the media casting device and the client device of FIG. 1 according to various embodiments of the present disclosure.

FIG. 3 is a top-level flowchart illustrating examples of functionality implemented as portions of the media casting device and the client device of FIG. 1 for providing an emulation service for performing corresponding actions based on a sequence of actions performed by a beauty advisor according to various embodiments of the present disclosure.

FIG. 4 illustrates the client device emulating the application of a makeup effect performed by a beauty advisor where the operations performed by the beauty advisor are analyzed by the media casting device of FIG. 1 according to various embodiments of the present disclosure.

FIG. 5 illustrates an example user interface displayed on the client device of FIG. 1 according to various embodiments of the present disclosure.

FIG. 6 illustrates the virtual application of makeup effects to the facial region of the user of the client device being synchronized with the sequence of operations performed by the beauty advisor according to various embodiments of the present disclosure.

FIG. 7 illustrates an example user interface displayed on the client device of FIG. 1 according to an alternative embodiment of the present disclosure.

### DETAILED DESCRIPTION

Consumers invest a substantial amount of money in makeup tools and accessories to achieve a desired look. However, it can be challenging for consumers to achieve the same results as a makeup professional even with the aid of conventional self-help guides. Embodiments are disclosed for implementing an emulation service for performing corresponding actions based on a sequence of actions or operations performed by a beauty advisor, where the beauty advisor provides viewers with a step-by-step makeup tutorial for applying cosmetic products. A description of a networked environment that includes a media casting device 102 and a client device 122 for implementing an emulation service for performing corresponding actions based on a sequence of actions depicted in a video is disclosed followed by a discussion of the operation of the components within the system.

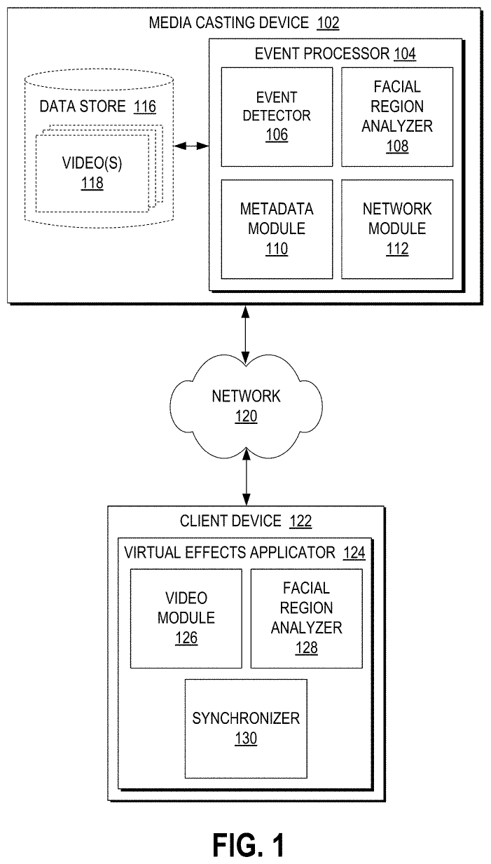

FIG. 1 is a block diagram of a networked environment that includes a media casting device 102 and a client device 122 in which the techniques for implementing an emulation service for events may be implemented. The media casting device 102 may be embodied as, but not limited to, a smartphone, a tablet computing device, a laptop computer, a cloud-based computing device, or any other system providing computing capability. Alternatively, the media casting device 102 may employ one or a plurality of computing devices that can be arranged, for example, in one or more server banks, computer banks or other arrangements. Such computing devices can be located in a single installation or can be distributed among different geographical locations.

The networked environment also includes a client device 122 where each client device 122 may similarly be embodied as, but not limited to, a smartphone, a tablet computing device, a laptop computer, and so on. Both the media casting device 102 and the client device 122 are equipped with digital content recording capabilities such as a front facing camera.

The media casting device 102 and the client device 122 are communicatively coupled to each other via a network 120 such as, for example, the Internet, intranets, extranets, wide area networks (WANs), local area networks (LANs), wired networks, wireless networks, or other suitable networks, etc., or any combination of two or more such networks. Through the network 120, the client device 122 receives video content of an event recorded by the media casting device 102.

An event processor 104 executes on a processor of the media casting device 102 and includes an event detector 106, a facial region analyzer 108, a metadata module 110, and a network module 112. The event detector 106 is configured to detect a beauty advisor performing a sequence of operations relating to application of makeup effects on a facial region of the beauty advisor. For some embodiments, the event detector 106 may be further configured to record a video 118 of the beauty advisor, where the event detector 106 records an entire event and sends the recorded video 118 to the client device 122. For other embodiments, the event detector 106 is configured to live stream an event hosted by the beauty advisor. The event detector 106 also stores information relating to the detected sequence of operations as metadata, where the video 118 and the metadata are stored in a data store 116 of the media casting device 102.

As one of ordinary skill will appreciate, the videos 118 recorded by the event detector 106 may be encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), or any number of other digital formats.

The event detector 106 is further configured to detect information or attributes relating to each of the sequence of operations, including a corresponding timestamp for each operation where each timestamp reflects when a corresponding operation was initiated and completed. The event detector 106 also detects such attributes as the angle, speed, force, thickness of the applied cosmetic effect, and direction related to a cosmetic product, finger, or cosmetic tool utilized in applying each cosmetic effect to the facial region.

The event detector 106 is further configured to detect the specific cosmetic products or cosmetic tools used during the sequence of operations and store this information in the data store 116. The facial region analyzer 108 is also configured to detect facial feature points of the beauty advisor. The metadata module 110 is configured to generate metadata that includes the sequence of operations, the facial feature points of the beauty advisor, position information relating to the application each cosmetic product, corresponding timestamps, each detected cosmetic product, and so on. Where applicable, the position information may be based on the position of a pointer of the cosmetic product.

In addition to storing the facial feature points of the beauty advisor, the metadata module 110 is also configured to store such information as the starting point or region and the end point or region of each facial feature or timestamp in which a cosmetic product was applied to by the beauty advisor. For example, if the beauty advisor applies lipstick, the facial region analyzer 108 tracks the starting point or region on the lips as the beauty advisor begins to apply lipstick. The facial region analyzer 108 also tracks the end point, region, timestamp, etc. relating to application of lipstick on the lips by the beauty advisor. This information is included in the metadata sent to the client device 122.

The metadata module 110 is also configured to store information relating to how operations are performed by the beauty advisor. This includes the sequence in which each operation is performed by the beauty advisor. Other information includes such attributes as the angle, speed, force, thickness of the applied cosmetic effect, and the direction in which each cosmetic product, cosmetic tool, and/or finger is used to apply a corresponding cosmetic to the facial region. Other information stored by the metadata module 110 includes the color and texture of each cosmetic product applied by the beauty advisor.

As described above, the event detector 106 may be configured to detect the presence of certain cosmetic products being utilized by the beauty advisor. For some embodiments, the cosmetic tools or products may be specified by the beauty advisor. For other embodiments, an object recognition algorithm may be applied to detect the specific cosmetic products or cosmetic tools being utilized by the beauty advisor. For such embodiments, the event detector 106 detects the presence of a cosmetic product (e.g., lipstick) in the video and automatically analyzes such attributes as the color of the cosmetic product, unique markings on the cosmetic product, unique packaging of the cosmetic product, and so on.

The cosmetic product or cosmetic tool may also be detected based on where the object is located on the facial region (e.g., lipstick on the lips). The event detector 106 then compares the image of the cosmetic product or cosmetic tool with pre-stored images or product templates found in the data store 116, where the images or product templates have corresponding metadata. The event detector 106 compares the attributes of the detected cosmetic product with information found in the metadata for each product template to identify specific product information relating to the detected cosmetic product. If an exact match is not found, the event detector 106 may provide the user with a comparable cosmetic product or cosmetic tool that closely matches the detected cosmetic product or cosmetic tool.

Based on the detection of specific cosmetic tools or products, the event detector 106 is further configured to automatically identify the target facial features in which the detected cosmetic products are being applied to. Such data may be included in the metadata generated by the metadata module 110. For example, suppose that the event detector 106 detects the presence of an eyebrow brush being held by the beauty advisor. Based on this, the event detector 106 determines that the beauty advisor will be applying a cosmetic product to the eyebrows of the beauty advisor. The metadata module 110 embeds not only the timestamp associated with application of the cosmetic product, but also the target facial feature (e.g., eyebrows) in the metadata later sent to the client device 122. The network module 112 is configured to transmit the metadata to a client device 122, which the client device 122 utilizes to emulate the actions of the beauty advisor.

The client device 122 includes a virtual effects applicator 124 executed on a processor of the client device 122 and includes a video module 126, a facial region analyzer 128, and a synchronizer 130. For implementations where the media casting device 102 records a video of the beauty advisor, the video module 126 is configured to obtain the video recorded by the media casting device 102 and the metadata generated by the media casting device 102. The video module 126 is also configured to record a video of a user of the client device 122 using, for example, a front facing camera. The facial region analyzer 128 is configured to detect facial feature points of the user for purposes of emulating operations depicted in the video recorded by the media casting device 102. In particular, the synchronizer 130 is configured to perform virtual application of makeup effects on the facial feature points of the user according to the metadata, where the virtual application of makeup effects on the facial feature points of the user is performed as corresponding operations are being depicted in the recorded video.

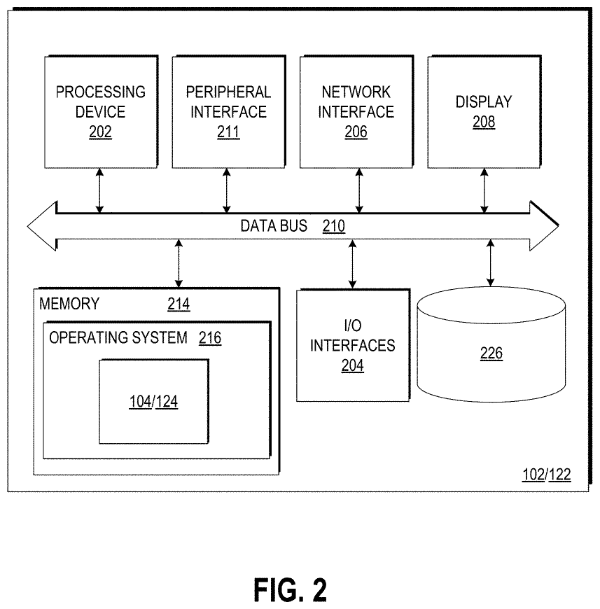

FIG. 2 illustrates a schematic block diagram of components found in both the media casting device 102 and the client device 122 in FIG. 1. Each device 102, 122 may be embodied as a desktop computer, portable computer, dedicated server computer, multiprocessor computing device, smart phone, tablet, and so forth. As shown in FIG. 2, each device 102, 122 comprises memory 214, a processing device 202, a number of input/output interfaces 204, a network interface 206, a display 208, a peripheral interface 211, and mass storage 226, wherein each of these components are connected across a local data bus 210.

The processing device 202 may include a custom made processor, a central processing unit (CPU), or an auxiliary processor among several processors associated with the media casting device 102, a semiconductor based microprocessor (in the form of a microchip), a macroprocessor, one or more application specific integrated circuits (ASICs), a plurality of suitably configured digital logic gates, and so forth.

The memory 214 may include one or a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components of the media casting device 102 and the client device 122 displayed in FIG. 1.

In accordance with such embodiments, the components are stored in memory 214 and executed by the processing device 202, thereby causing the processing device 202 to perform the operations/functions disclosed herein. For some embodiments, the components in the media casting device 102 may be implemented by hardware and/or software.

Input/output interfaces 204 provide interfaces for the input and output of data. For example, where the media casting device 102 comprises a personal computer, these components may interface with one or more user input/output interfaces 204, which may comprise a keyboard or a mouse, as shown in FIG. 2. The display 208 may comprise a computer monitor, a plasma screen for a PC, a liquid crystal display (LCD) on a hand held device, a touchscreen, or other display device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

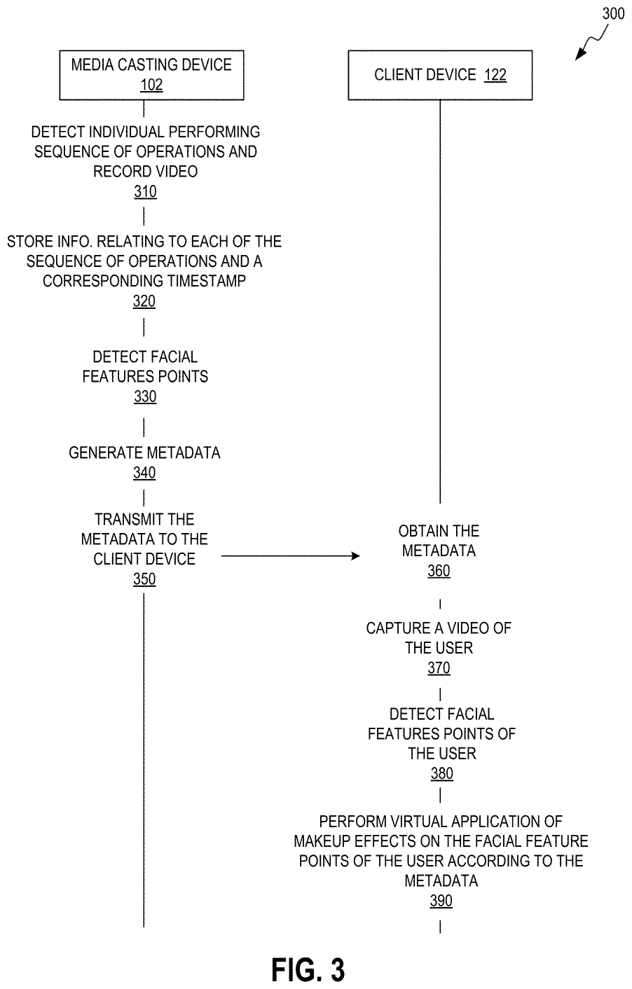

Reference is made to FIG. 3, which is a flowchart 300 in accordance with various embodiments for providing an emulation service for performing corresponding actions based on a sequence of actions performed by a beauty advisor, where the operations in FIG. 3 are performed by the media casting device 102 and the client device 122 of FIG. 1. It is understood that the flowchart 300 of FIG. 3 provides merely an example of the different types of functional arrangements that may be employed to implement the operation of the various components of the media casting device 102 and the client device 122. As an alternative, the flowchart 300 of FIG. 3 may be viewed as depicting an example of steps of a method implemented in the media casting device 102 and the client device 122 according to one or more embodiments.

Although the flowchart 300 of FIG. 3 shows a specific order of execution, it is understood that the order of execution may differ from that which is displayed. For example, the order of execution of two or more blocks may be scrambled relative to the order shown. Also, two or more blocks shown in succession in FIG. 3 may be executed concurrently or with partial concurrence. It is understood that all such variations are within the scope of the present disclosure.

At block 310, the media casting device 102 detects a beauty advisor performing a sequence of operations or actions relating to the application of cosmetic products on a facial region of the beauty advisor. In some embodiments, the media casting device 102 records the sequence of operations in a video where the video is later sent to the client device 122. The video recorded by the media casting device 102 may correspond, for example, to a live event of the beauty advisor performing a makeup tutorial. During the makeup tutorial, the beauty advisor may apply actual makeup or perform virtual application of makeup. As an alternative to recording an entire event and sending a recorded video to the client device 122, the media casting device 102 may perform live streaming of the actions or operations performed by the beauty advisor.

At block 320, the media casting device 102 stores information relating to each of the detected sequence of operations and a corresponding timestamp for each operation, where each timestamp reflects when a corresponding operation was initiated. The information relating to each of the detected sequence of operations and a corresponding timestamp for each operation is stored as metadata.

At block 330, the media casting device 102 detects facial feature points of the beauty advisor. At block 340, the media casting device 102 generates metadata comprising the sequence of operations, the facial feature points of the beauty advisor, and the corresponding timestamps. The metadata may also include product information corresponding to each cosmetic product applied during the sequence of operations, where the product information may include, for example, color information, texture information, and information on how to acquire the cosmetic products. This product information may be displayed in the user interface when a corresponding makeup effect is being applied to the user during the sequence of operations performed by the beauty advisor.

The metadata generated by the media casting device 102 further comprises a starting point, an end point, and/or a timestamp relating to application of each cosmetic effect to each facial feature. The metadata may also comprise a starting point, an end point, and/or a timestamp relating to each operation. This information may include, for example, the coordinates of the cosmetic tool used for each operation in which each cosmetic product is applied by the beauty advisor. Where applicable, the coordinates may correspond to a pointer of the cosmetic tool. The metadata may also include an angle, speed, force, thickness, and direction in which each cosmetic product or the cosmetic tool is applied to the facial region by the beauty advisor. The metadata may also include the coordinates of the position of the cosmetic product/tool relative to the facial feature points. At block 350, the media casting device 102 transmits the recorded video and the metadata to a client device 122.

At block 360, the client device 122 obtains the metadata, and at block 370, the client device 122 records a video of a user of the client device. At block 380, the client device 122 detects facial feature points of the user. At block 390, the client device 122 performs virtual application of makeup effects on the facial feature points of the user according to the metadata. For some embodiments, the virtual application of makeup effects on the facial feature points of the user is displayed in a user interface and is performed as corresponding operations are depicted in the recorded video, thereby allowing the user to emulate the application of cosmetic products being performed by the beauty advisor.

For some embodiments, the progression in which the virtual application of makeup effects is performed on the facial feature points of the user aligns with the progression of each corresponding operation depicted in the video such that the virtual application of makeup effects is synchronized with the actual application of cosmetic products by the beauty advisor. For some embodiments, the virtual application of makeup effects on the facial feature points of the user and the application of cosmetic products on the facial region of the beauty advisor are displayed in respective display windows in the user interface displayed on the client device 122. For embodiments where the media casting device 102 records a video of the beauty advisor, the user interface displayed on the client device 122 may also include playback controls for allowing the user to perform time-shifted playback of the recorded video. Thereafter, the process in FIG. 3 ends.

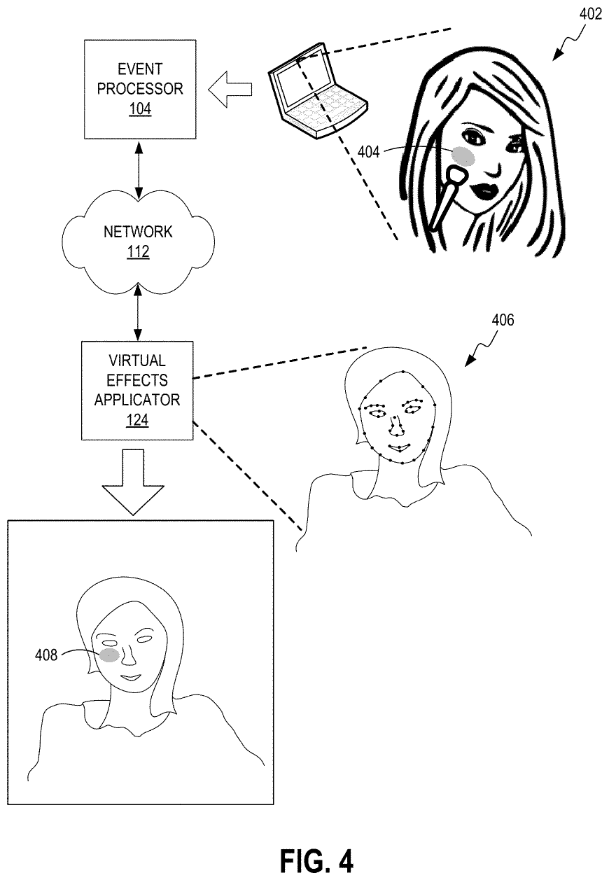

To further illustrate various aspects of the present invention, reference is made to the following figures. FIG. 4 illustrates the client device 122 emulating the application of a cosmetic product performed by a beauty advisor where the operations performed by the beauty advisor are detected and analyzed by the media casting device 102. In the example shown, the media casting device 102 detects the beauty advisor applying a blush cosmetic product 404 to the facial region 402 of the beauty advisor. As described earlier, the beauty advisor may either apply actual blush cosmetic product 404 to the facial region 402 or perform virtual application of the blush cosmetic product 404 to the facial region 402.

The event detector 106 detects the sequence of operations or actions performed by the beauty advisor and logs a timestamp for each operation. The facial region analyzer 108 extracts facial feature points in the facial region 402 of the beauty advisor to facilitate the virtual application of makeup effects on corresponding facial feature points in the facial region of the user of the client device 122. This information is stored as metadata and sent by the media casting device 102 to the client device 122.

The virtual effects applicator 124 executing in the client device 122 receives the video and the metadata. Note that the media casting device 102 is not limited to recording a video depicting an entire event relating to operations performed by the beauty advisor. In some embodiments, the client device 122 may receive a live stream of an event involving the beauty advisor from the media casting device 102 where the media casting device 102 buffers small segments or portions of the event and periodically transmits the buffered segments to the client device 122 upon analyzing the segments. The virtual effects applicator 124 extracts facial feature points in the facial region 406 of the user of the client device 122. In the example shown, a blush makeup effect 408 is applied to the facial region 406 of the user at the same time that the beauty advisor applies the blush cosmetic product 404.

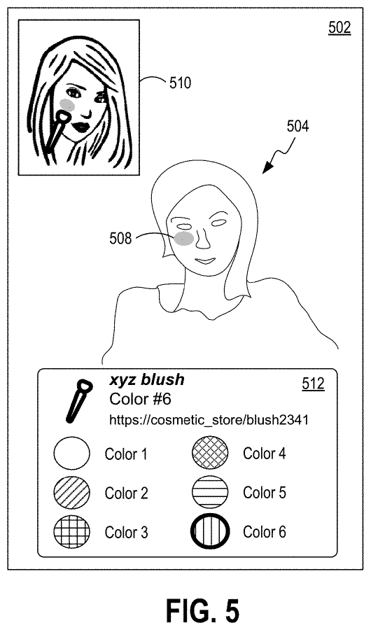

FIG. 5 illustrates an example user interface 502 displayed on the client device 122 in FIG. 1. The user interface 502 displays a video of the user recorded by the client device 122. In addition to the main display area that shows the facial region 504 of the user, the user interface 502 may also include a first display window 510 that displays the video of the beauty advisor recorded by the media casting device 102 (FIG. 1). As shown, a makeup effect 508 is applied to the facial region 504 of the user at the same time that the beauty advisor shown in the first display window 510 applies a corresponding cosmetic product. The user interface 502 may also include a second display window 512 that displays product information associated with the cosmetic product current being applied by the beauty advisor depicted in the first display window 510. The product information displayed to the user also includes the cosmetic tool utilized in applying the cosmetic product.

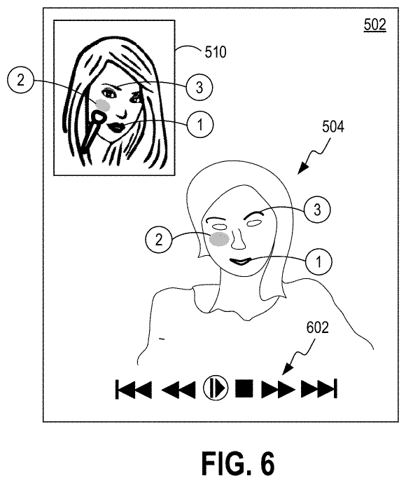

FIG. 6 illustrates the virtual application of makeup effects to the facial region of the user of the client device 122 being synchronized with the sequence of operations performed by the beauty advisor. The operations of the beauty advisor are shown in the display window 510 of the user interface 502. In the example shown, the beauty advisor in the display window 510 performs a sequence of three operations, where the beauty advisor applies lipstick, blush, and then eyeliner in succession. The beauty advisor may either apply actual lipstick, blush, and eyeliner to the facial region 504 or perform virtual application of the lipstick, blush, and eyeliner to the facial region 504. The same sequence of virtual makeup effects is applied by the virtual effects applicator 124 (FIG. 1) to the facial region 504 of the user of the client device 122 (FIG. 1).

The virtual effects applicator 124 executing in the client device 122 emulates the sequence of operations performed by the beauty advisor using the information contained in the metadata sent by the media casting device 102. As described earlier, the metadata comprises information relating to the sequence of operations performed by the beauty advisor. The metadata also includes information relating to the facial feature points of the beauty advisor as well timestamp information relating to each operation, thereby allowing the virtual effects applicator 124 executing in the client device 122 to synchronize the virtual application of makeup effects on the same facial feature points in the facial region 504 of the user with the operations performed by the beauty advisor.

For some embodiments, the user interface 502 also includes playback controls 602 that allow the user to control playback of the various operations performed by the beauty advisor. For example, the user can pause playback or rewind the video to view the application of a particular cosmetic product performed earlier by the beauty advisor. Where the media casting device 102 is streaming a live event of the beauty advisor performing a makeup tutorial, the playback controls 602 allow the user to perform time-shifted playback of the live event. During live streaming of an event, the media casting device 102 is configured to temporarily record or buffer a video corresponding to portions of the event (e.g., t seconds) and analyze the buffered video.

The media casting device 102 then sends the analyzed portions (t seconds of video) to the client device 122. Note that the parameter (t) can be any real number and is not limited to integer values. In some embodiments, the media casting device 102 is configured to buffer and analyze a single frame at a time and transmit the single frame to the client device 122 to minimize the delay in viewing the live event. This also reduces the amount of storage space utilized in the media casting device 102 for buffering videos of the live event. By using the playback controls 602, the user can watch a recorded video at a specific point in time or can join a live broadcast at any point in time.

To further illustrate the playback features described above, suppose that the beauty advisor applies lipstick, blush, and then eyeliner in succession. Assume for this example that the media casting device 102 has recorded a video of an entire event and has transmitted the recorded video to the client device 122. The user can elect to fast forward playback of the recorded video and only watch the beauty advisor apply eyeliner. In this regard, the user can skip portions of the video depicting application of the lipstick and blush and only view the portion of interest depicting application of the eyeliner. Similarly, the user is not limited to viewing a live broadcast from the beginning of the event. For example, the user can jump to the portion of interest depicting application of the eyeliner. By using the playback controls 602, the user can also rewind the recorded video to view one or more operations of interest. For some embodiments, the playback controls 602 may comprise a slider bar to facilitate the playback of the video where the user manipulates the slider bar to fast forward and/or rewind the video to view one or more operations of interest.

Referring back to FIG. 1, an alternative embodiment of a system for implementing an emulation service is now described. In the alternative embodiment described below, the emulation service is implemented using the components in FIG. 1. In this embodiment, the event detector 106 includes a streaming module configured to obtain a multimedia file where the multimedia file is then transmitted by the network module 112 to the client device 122 for a user to view the multimedia file. The multimedia file depicts an individual such as a beauty advisor performing a sequence of operations relating to the application of cosmetic products on a facial region of the beauty advisor.

The multimedia file obtained by the streaming module may include videos encoded in formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), an MPEG Audio Layer III (MP3), an MPEG Audio Layer II (MP2), Waveform Audio Format (WAV), Windows Media Audio (WMA), or any number of other digital formats.

For this alternative embodiment, the metadata module 110 described earlier is not utilized to generate metadata. Instead, the metadata module 110 is configured to download metadata from a server (not shown) where the metadata is associated with the multimedia file obtained by the streaming module. The metadata obtained by the metadata module 110 comprises information relating to each of the sequence of operations and a corresponding timestamp for each operation, where each timestamp reflects when a corresponding operation was initiated and completed. The metadata further comprises such attributes as the angle, speed, force, thickness and direction related to a tool/product/finger in which a particular cosmetic is applied to the facial region.

The metadata also comprises one or more cosmetic tools used during the sequence of operations as well as facial feature points of the beauty advisor. The metadata may also include such information as the starting point or region and the end point or region/timestamp of each facial feature in which a cosmetic product was applied to by the beauty advisor. The metadata may also include the sequence in which each operation is performed by the beauty advisor. Other information found in the metadata includes such attributes as the angle, speed, force, and the direction in which each cosmetic tool is used to apply a corresponding cosmetic to the facial region. Other information found in the metadata includes the color and texture of each cosmetic product applied by the beauty advisor.

As discussed earlier, the client device 122 includes a virtual effects applicator 124 executed on a processor of the client device 122 and includes a video module 126, a facial region analyzer 128, and a synchronizer 130. The video module 126 is configured to obtain the multimedia file and the metadata obtained by the media casting device 102. The video module 126 is also configured to record a video of a user of the client device 122 using, for example, a front facing camera.

The facial region analyzer 128 is configured to detect facial feature points of the user for purposes of emulating operations depicted in the video recorded by the media casting device 102. In particular, the synchronizer 130 is configured to perform virtual application of makeup effects on the facial feature points of the user according to the metadata, where the virtual application of makeup effects on the facial feature points of the user is performed as corresponding operations are being depicted in the recorded video.

The user of the client device 122 in FIG. 1 views the multimedia file obtained by the streaming module on the client device 122. While viewing the multimedia file depicting the beauty advisor on the client device 122, the user may elect to try on various cosmetic products being applied by the beauty advisor depicted in the multimedia file. To initiate this process, the user manipulates a user interface control displayed on the client device 122. The streaming module executing in the media casting device 102 detects manipulation of the user interface control and in response, issues a command to cause the client device 122 to capture a video of a facial region of the user and track facial feature points of the user in the video.

The streaming module also issues a command to cause the client device to perform virtual application of makeup effects on the facial feature points of the user of the client device according to the metadata obtained earlier by the metadata module 110. The virtual application of makeup effects on the facial feature points of the user is displayed in a user interface on the client device 122 and is performed as corresponding operations are performed by the beauty advisor. Furthermore, a progression in which the virtual application of makeup effects is performed on the facial feature points of the user of the client device 122 aligns with a progression of each corresponding operation performed by the beauty advisor such that the virtual application of makeup effects is synchronized with the application of cosmetic products by the beauty advisor.

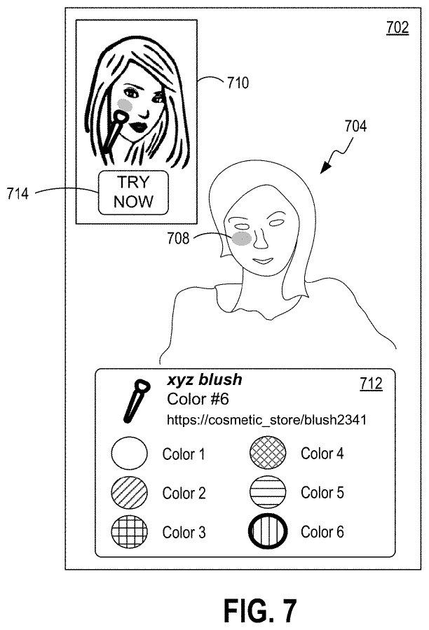

To further illustrate various aspects of the alternative embodiment described above, reference is made to FIG. 7, which illustrates an example user interface 702 displayed on the client device 122 in FIG. 1. The user interface 702 displays a video of the user recorded by the client device 122. In addition to the main display area that shows the facial region 704 of the user, the user interface 702 may also include a first display window 710 that displays a video of the beauty advisor obtained by the media casting device 102 (FIG. 1) from a server.

The first display window 710 displaying the beauty advisor includes a user interface control 714 that allows the user to initiate a virtual application process whereby the same makeup effects being applied to the facial region of the beauty advisor are applied on the facial region of the user. In particular, when the user manipulates the user interface control 714, a makeup effect 708 is applied to the facial region 704 of the user at the same time that the beauty advisor shown in the first display window 710 applies a corresponding cosmetic product, where virtual application of the makeup effect 708 is applied based on metadata retrieved by the media casting device 102.

In the example shown, the user clicks on the “Try Now” button to initiate the virtual application process. The user interface 702 may also include a second display window 712 that displays product information associated with the cosmetic product current being applied by the beauty advisor depicted in the first display window 710, where the product information is included in the metadata retrieved by the media casting device 102. The product information displayed to the user also includes the cosmetic tool utilized in applying the cosmetic product.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method, comprising:
detecting, by a facial region analyzer, facial feature points of a beauty advisor;
detecting, by an event detector, the beauty advisor performing a sequence of operations relating to application of cosmetic products on a facial region of the beauty advisor;
detecting, by the event detector, a corresponding timestamp for each operation;
detecting, by the event detector, a position of a cosmetic product with respect to facial feature points of the beauty advisor during each of the sequence of operations;
detecting, by the event detector, a cosmetic product utilized by the beauty advisor during each of the sequence of operations;
generating, by a metadata module, metadata comprising the sequence of operations, the position of each cosmetic product, the corresponding timestamps, and each detected cosmetic product; and
transmitting, by a network module, the metadata to a client device.

2. The method of claim 1, wherein detecting, by the event detector, the position of the cosmetic product comprises determining coordinates of the position of the cosmetic product relative to the facial feature points.

3. The method of claim 1, further comprising causing the client device to perform virtual application of makeup effects on facial feature points of a user of the client device according to the metadata,
wherein the virtual application of makeup effects on the facial feature points of the user is displayed in a user interface on the client device and is performed as corresponding operations are performed by the beauty advisor, and
wherein a progression in which the virtual application of makeup effects is performed on the facial feature points of the user of the client device aligns with a progression of each corresponding operation performed by the beauty advisor such that the virtual application of makeup effects is synchronized with the application of cosmetic products by the beauty advisor.

4. The method of claim 3, wherein the virtual application of makeup effects on the facial feature points of the user is displayed in the user interface on the client device with a corresponding cosmetic product specified in the metadata.

5. The method of claim 3, wherein the virtual application of the makeup effects on the facial feature points of the user of the client device and the virtual application of the makeup effects on the facial region of the beauty advisor are displayed in respective display windows in the user interface displayed on the client device.

6. The method of claim 1, wherein detecting the beauty advisor performing the sequence of operations is performed during a live event of the beauty advisor performing a makeup tutorial, and
wherein the network module performs live streaming of the live event.

7. The method of claim 1, further comprising:
recording, by the event detector, a video depicting the beauty advisor performing the sequence of operations relating to application of cosmetic products on a facial region of the beauty advisor; and
transmitting the video to the client device.

8. The method of claim 7, further comprising causing a user interface to be displayed on the client device, the user interface comprising playback controls for time-shifted playback of the recorded video obtained by the client device relating to a live event.

9. The method of claim 1, wherein the metadata further comprises product information corresponding to each cosmetic product applied during the sequence of operations, the product information comprising color information, texture information, and information for acquiring the cosmetic products.

10. The method of claim 9, further comprising causing the product information to be displayed in a user interface on the client device when a corresponding makeup effect is being applied during the sequence of operations.

11. The method of claim 1, wherein the metadata further comprises at least one of: a starting point, an end point, a timestamp, an angle, force, thickness, or direction of each facial feature in which each cosmetic product or finger is applied to the facial region by the beauty advisor.

12. A method, comprising:
obtaining, by a streaming module, a multimedia file depicting a beauty advisor performing a sequence of operations relating to application of cosmetic products on a facial region of the beauty advisor;
obtaining, by a metadata module, metadata, wherein the metadata comprises: the sequence of operations, a position of a cosmetic product, corresponding timestamps, and each cosmetic product utilized by the beauty advisor;
detecting, by an event detector, manipulation of a user interface control of a user of a client device; and
responsive to detecting the manipulation of the user interface control, performing the steps of:
causing the client device to capture a video of a facial region of the user;
causing the client device to track facial feature points of the user in the video; and
causing the client device to perform virtual application of makeup effects on the facial feature points of the user of the client device according to the metadata, wherein the virtual application of makeup effects on the facial feature points of the user is displayed in a user interface on the client device and is performed as corresponding operations are performed by the beauty advisor.

13. The method of claim 12, wherein the virtual application of makeup effects on the facial feature points of the user is displayed in the user interface on the client device with a corresponding cosmetic product specified in the metadata.

14. The method of claim 12, wherein the virtual application of the makeup effects on the facial feature points of the user of the client device and the virtual application of the makeup effects on the facial region of the beauty advisor are displayed in respective display windows in the user interface displayed on the client device.

15. The method of claim 12, wherein the metadata further comprises at least one of: a starting point, an end point, a timestamp, an angle, force, thickness, or direction of each facial feature in which each cosmetic product or finger is applied to the facial region by the beauty advisor.

16. A non-transitory computer-readable storage medium storing instructions to be implemented by a media casting device having a processor, wherein the instructions, when executed by the processor, cause the media casting device to at least:
detect facial feature points of a beauty advisor;
detect the beauty advisor performing a sequence of operations relating to application of cosmetic products on a facial region of the beauty advisor;
detect a corresponding timestamp for each operation;
detect a position of a cosmetic product with respect to facial feature points of the beauty advisor during each of the sequence of operations;
detect a cosmetic product utilized by the beauty advisor during each of the sequence of operations;
generate metadata comprising the sequence of operations, the position of each cosmetic product, the corresponding timestamps, and each detected cosmetic product; and
transmit the metadata to a client device.

17. The non-transitory computer-readable storage medium of claim 16, wherein the processor is further configured by the instructions to cause the client device to perform virtual application of makeup effects on facial feature points of a user of the client device according to the metadata,
wherein the virtual application of makeup effects on the facial feature points of the user is displayed in a user interface on the client device and is performed as corresponding operations are performed by the beauty advisor, and
wherein a progression in which the virtual application of makeup effects is performed on the facial feature points of the user of the client device aligns with a progression of each corresponding operation performed by the beauty advisor such that the virtual application of makeup effects is synchronized with the application of cosmetic products by the beauty advisor

18. The non-transitory computer-readable storage medium of claim 16, wherein the processor is further configured by the instructions to detect the beauty advisor performing the sequence of operations during a live event of the beauty advisor performing a makeup tutorial, and wherein the processor is configured by the instructions to perform live streaming of the live event.

19. The non-transitory computer-readable storage medium of claim 16, wherein the processor is further configured by the instructions to:
record a video depicting the beauty advisor performing the sequence of operations relating to application of cosmetic products on a facial region of the beauty advisor; and
transmit the video to the client device.

20. A non-transitory computer-readable storage medium storing instructions to be implemented by a client device having a processor, wherein the instructions, when executed by the processor, cause the client device to at least:
obtain a video and metadata from a media casting device, the video depicting a beauty advisor performing a sequence of operations relating to application of cosmetic products on a facial region of the beauty advisor;
capture a video of a user of the client device;
detect facial feature points of the user; and
perform virtual application of makeup effects on the facial feature points of the user according to the metadata, wherein the virtual application of makeup effects on the facial feature points of the user is displayed in a user interface and is performed as corresponding operations are depicted in the video obtained from the media casting device.

21. The non-transitory computer-readable storage medium of claim 20, wherein a progression in which the virtual application of makeup effects is performed on the facial feature points of the user aligns with a progression of each corresponding operation depicted in the video obtained from the media casting device such that the virtual application of makeup effects is synchronized with the application of cosmetic products by the beauty advisor.

22. The non-transitory computer-readable storage medium of claim 20, wherein the virtual application of the makeup effects on the facial feature points of the user and the virtual application of the makeup effects on the facial region of the beauty advisor are displayed in respective display windows in the user interface displayed on the client device.

23. The non-transitory computer-readable storage medium of claim 20, wherein the video depicting the beauty advisor performing the sequence of operations corresponds to a live event of the beauty advisor performing a makeup tutorial, and wherein the user interface displayed on the client device further comprises playback controls for time-shifted playback of the video obtained by the client device relating to the live event.

24. The non-transitory computer-readable storage medium of claim 20, wherein the metadata obtained from the media casting device comprises a starting point and an end point of each facial feature in which each cosmetic product is applied by the beauty advisor.
